(19) United States
(12) Patent Application Publication
(10) Pub. No.: US 2008/0103935 A1
(43) Pub. Date: May 1, 2008

(54) System and method of global electronic trade in the Internet

(76) Inventor: Valentina Pulnikova, Villingen-Schwenningen (DE)

Correspondence Address: DR. PULNIKOVA VALENTINA, WEIHERSTRASSE 9, VILLINGEN-SCHWENNINGEN, 78050, omitted

(21) Appl. No.: 11/834,810

(22) Filed: Aug. 7, 2007

Related U.S. Application Data
(63) Continuation-in-part of application No. 11/586,708, filed on Oct. 26, 2006.

(51) Int. Cl. G06Q 30/00

(52) U.S. Cl. 705/27

(57) ABSTRACT

A system and method of global and local electronic trade in the Internet is provided. The method of global and local electronic trade for sellers and buyers via the Internet includes registering the sellers and the buyers; providing information regarding goods or services to the registered sellers and buyers; selecting trade partners based on the provided information; holding tenders of the trade partners; conducting transactions between the trade partners; conducting a post-transaction procedures; and protecting the seller and the buyer information.

### CROSS-REFERENCE TO RELATED APPLICATIONS

This application is continuation-in-part of application Ser. No. 11/586,708 filed Oct. 26, 2006.

### BACKGROUND

1. Field of the Disclosure

This invention relates, in general, to electronic commerce and, more particularly, to global Business-to-Business trade in the Internet.

2. Description of the Related Art

At present there are three well-known forms of electronic trade:

1. Business-to-Individual. The Web site Amazon.com is a typical example of this trade form. In this form electronic shops sell consumer goods to individual buyers. In general this is a retail trade.

2. Individual-to-Individual. The well-known Web site e-bay.com is an example of this trade form. In this case individual sellers sell consumer goods to individual buyers. Generally this is also a retail trade.

3. Business-to-Business (B2B). There are a number of Web sites operating in this form, such as eceurope.com, esourses.co.uk, wand.com, tbc-world.com, globalsourse.com, perfect.com, freemarkets.com, metalsite.com, enron.com, busytrade.com, marginup.com, allactiontrade.com, b2bquote.com and others. In this form a company wholesales products and services to another company.

Characteristic features of all sites of B2B trade form are the availability of registration of a member of the site, the availability of an expanded catalogue of goods and services including different branches of industry and services, the availability of a seller section and a buyer section.

Disadvantages of existing B2B sites include:
The absence of information on prices of proposed goods and services;
absence of information on the quality and technical characteristics of proposed goods and services;
The absence of a possibility of a various selection of goods and services according to wishes of buyers or sellers;
The absence of possibility for announcing and holding tenders;
In general, the existing sites are informational sites, and therefore there are no options for contracts and transactions in the frame of these sites;
Most existing sites take no measures for restricting an access for unwanted users, who can impede the normal operation of the site; and
Limited multilingual support.

At present, trade of goods and services between companies encounters problems, which especially concerns companies producing means of production and offering production and technological services. The above-mentioned Web sites enable limited electronic B2B trade and offer expanded data catalogues. However, the primary information about goods and services is kept on the sites of producers. Further, this information is often incomplete. Typically, information on prices of required goods or services is missing on existing sites of companies and on existing sites of electronic trade. Therefore, for example, a buyer must contact a number of producers in order to make an inquiry on the price and properties of goods before concluding a contract.

It is even more difficult to collect required information on trade partners for a seller in the field of wholesale trade. While some electronic B2B trade sites have sections of sellers and buyers, the absence of complete information about characteristics of needed goods impedes searching of trade partners.

Thus, there exists a deficiency of information on possible partners, prices, requirements to goods and services, which makes it difficult, for example, for producers to perform an analysis of the efficiency of their business transactions, plan production of goods and services, and make an analysis of their own prices and compare them with the prices of other producers. It is also difficult, for example, for buyers to compare prices of sellers, make a comparison of quality performances of goods and services, and make an analysis of the market. These current limitations impede the progress of the world market.

Another problem is a classification of branches of industry, and other directions of activity, goods and services in the global system. This problem impedes a high-quality search for trade partners because there are potential sources of inaccuracies during construction of databases and during searching since the same goods can belong to different categories.

Another problem is the fact that existing sites of B2B electronic trade are not really global. They are regional or branch-wise in general.

Another problem is reliability, confidentiality and security of information allocated in Web sites, which keeps companies on the alert and, again, impedes business.

Additionally, there is a problem with reliability of a contract. B2B Web sites do not address this concern. Rather, they provide information only, and offer little, or no help, in securing a transaction. Such a concern is a most serious in the way of electronic trade.

Another problem concerns the absence of tenders in B2B sites. Since B2B sites limit their service for informational support, they do not offer a possibility for tenders.

Another problem related to B2B sites concerns relatively poor searching and/or sorting possibilities.

Accordingly, systems and methods are required that address these problems in the global wholesale trade.

### SUMMARY

An aspect of the embodiments discussed here is to provide a system and method for improved global electronic world trade in the Internet. According to an aspect of the present invention, such a system and method includes:
creation of a global information database on the basis of the Global Classification of Branches of Economy, Goods and Services (GC);
a system of searching and selection of trade partners;
a method of holding tenders;
a method of holding transactions;
a method of Controlled Advanced Payment (CAP), providing increased reliability for a transaction; and
a post-transaction procedure.

According an aspect of the present invention, the system and method has sufficient reliability for holding a transaction. The reliability of the method is provided during a registration stage, as well as during creating, searching, sorting and selecting information. The system and method includes special procedures for holding tenders, concluding contracts, assisting with payments and offering post-transaction services, the special security procedure.

According to an aspect of the embodiments discussed herein, a system and method of the global electronic trade via the Internet is proposed in this invention. The system includes a multilingual Web site, located on a host server, communication channels of the Internet and numerous users. The users are sellers and buyers, who are equitable participants of trade. Each user can be either a seller or a buyer, or both. Further, either a Company or an Individual can be a user.

After registration sellers and buyers provide their offers. On the basis of these offers a database is formed and stored on a host server. The database is formed on the basis of the Global Classification of Branches of Economy, Goods and Services (GC). The buyers and sellers can access this database. The buyers and sellers can perform different sorting. Upon a request of a buyer or a seller, a selection of desired goods or partners can be made. A result of selection becomes available to the user.

After analysis of the acquired information, the potential partners can negotiate in the frame of the system or outside it.

The buyers and sellers can announce and hold tenders. If a buyer announces a tender, he can do it in two different modes. In the first mode, the information about tender is automatically sent to partners via internal e-mail. The partners are selected on the basis of the declared demands of the buyer. In the second mode, the buyer sends information on the tender to the desired partners only. The participants of the tender are requested to send their offers to the organizer of the tender. In this case the tender is held as a competition. After stipulated time, the organizer of the tender declares the result to the participants of the tender. If a seller announces a tender, he can follow the same two modes. The organizer of the tender announces the time frame of the tender and the initial price. In this case the tender is held as an auction.

The trade partners can conclude a transaction either in the frame of the system or outside the system. If the transaction is concluded within the frame of the system a number of typical contracts are offered. The contract is stored in the database for a stipulated time. The payments can be realized via the system by means of the Controlled Advanced Payment (CAP) for better of reliability of a transaction. In this case, a buyer transfers the money to the account of the system. After that the system informs the seller about the money transfer by the buyer. After this message the seller is expected to deliver goods or offer services according to the contract. If everything is normal, the buyer sends no messages to the system, and the system automatically transfers the money to the seller's account according to terms specified in the contract. The transaction is finished successfully. In case of conclusion the contract in the frame of the system both trade partners get benefit in view of the information about number of the contracts realized in the frame of the system.

According to an aspect of the embodiments, a method of global electronic trade for sellers and buyers via the Internet includes, registering the sellers and the buyers; providing information regarding goods or services to the registered sellers and buyers; selecting trade partners based on the provided information; holding tenders of the trade partners; conducting transactions between the trade partners; conducting a post-transaction procedures; and protecting the seller and the buyer information.

According to an aspect of the embodiments, the method includes the sellers and buyers comprises filling a registration form for a subsequent check of data provided by a user into this form and for using this data for contract preparation or preparation of other official documents, providing information regarding goods or services comprises providing information regarding the Global Classification of Branches of Economy, Goods and Services (GC), searching and selecting trade partners by interactive searching for goods and services by a buyer, a seller, or a buyer and a seller or by automatic searching for goods and services by a buyer, a seller, or a buyer and a seller, and conducting negotiations, closing of the contract in case of a successful negotiation, and transfer of required money, and closing of the contract in case of a successful negotiation by signing the contract with an electronic signature or seal, and verifying the electronic signature or seal, and conducting a transaction procedure by reacting to possible conflict situations during realization of a contract concluded in the frame of the system of electronic trade, and: holding tenders by notification of potential participants about the tender, and declaration of the result of the tender, the protecting information includes, generating a code sent to a user together with the user password after the registration and further providing additional services of the system of global electronic trade including providing help for working in the system of global electronic trade with a number of examples or providing help regarding legal issues.

According to an aspect of the embodiments, a system of global electronic trade via the Internet for users including sellers and buyers as equitable trade participants includes a host server including a database and a Web-site or network communication program; and user computers capable of communicating with the host server, wherein the host server registers the users, provides information regarding goods or services to the user computers, searches and selects trade partners, holds tenders, conducts transactions; and protects information.

According to an aspect of the embodiments, a method of registration for global trade, includes filling a registration form for subsequent check of data provided by a user into the registration form and for using these data for a contract preparation and for preparation of other official documents; including a scanned signature or seal into the registration form; sending a letter to the user with a password and code generator; and encoding the electronic signature and the seal.

According to an aspect of the embodiments, a method of providing information for global trade, includes creating a database of goods and services on the basis of the Global Classification of Branches of Economy, Goods and Services (GC) including a price of offered and required goods and services and characteristics of offered and required goods and services; creating a database of information regarding companies, individual businessmen or private persons, including into this database of the main and additional data about companies or other juridical persons, Individual businessmen or private persons; and creating of the database of confidential information, which will be used for preparation of contracts and other official documents.

According to an aspect of the embodiments, a method of searching for required goods and services by a buyer, includes searching on a basis of Global Classification (GC) code; and sorting obtained search on the basis of a desired price or quality of goods or services.

According to an aspect of the embodiments, a method of protecting information in global trade includes generating a new password for every new entrance of a user into a system of global electronic trade.

According to an aspect of the embodiments, a system and method of local electronic trade via the Internet includes:
creation of an information database on the basis of the Global Classification of Branches of Economy, Goods and Services (GC), the Local Classification of Branches of Economy, Goods and Services (LC), the Classification of Properties and Characteristics of Goods or Services (CPC);
a system of searching and selection of trade partners;
a method of holding tenders;
a method of holding transactions;
a method of Controlled Advanced Payment (CAP), providing increased reliability for a transaction; and
a post-transaction procedure;
method of protecting the seller and the buyer information.

According to an aspect of the embodiments discussed herein, a system and method of the local electronic trade via the Internet is proposed in this invention also. The system includes a Web site, located on a host server, communication channels of the Internet and numerous users. The users are sellers and buyers, who are equitable participants of trade. Each user can be either a seller or a buyer, or both. Further, either a Company or an Individual can be a user.

Additional aspects will be set forth in part in the description which follows and, in part, will be apparent from the description and drawings, and from the claims.

### BRIEF DESCRIPTION OF THE DRAWINGS

These and/or other aspects and advantages of the embodiment will become more readily appreciated from the following description of the embodiments, taken in conjunction with the accompanying drawings of which:

FIG. 1a is block diagram of a system according to an embodiment;

FIG. 1b is a diagram of a method system according to an embodiment;

FIG. 2 is a flowchart showing registration according to an embodiment;

FIG. 3 is a flowchart showing a process of collecting information on companies according to an embodiment;

FIG. 4 is a diagram showing a process of collecting information on goods and services according to an embodiment;

FIG. 5 is a diagram showing a process of interactive searching by a buyer according to an embodiment;

FIG. 6 is a flowchart showing the process of interactive searching by a seller according to an embodiment;

FIG. 7 is a flowchart showing the process of automatic searching by a buyer according to an embodiment;

FIG. 8 is a flowchart showing the process of automatic searching by a seller according to an embodiment;

FIG. 9 is a flowchart showing a transaction according to an embodiment;

FIG. 10 is a flowchart showing the process of concluding contracts according to an embodiment;

FIG. 11 is a flowchart showing shows a detailed description of the Controlled Advanced Payment according to an embodiment;

FIG. 12 is a flowchart showing the procedure of solving conflicts and annulment of contracts according to an embodiment;

FIG. 13 is a flowchart showing the process of holding tenders by a buyer according to an embodiment;

FIG. 14 is a flowchart showing the process of holding tenders by a seller according to an embodiment;

FIG. 15 is a flowchart showing a post-transaction process according to an embodiment;

FIG. 16 is a flowchart showing additional services of the system according to an embodiment; and,

FIG. 17 is a flowchart showing a security procedure according to an embodiment.

### DETAILED DESCRIPTION

Reference will now be made in detail to embodiments, examples of which are illustrated in the accompanying drawings.

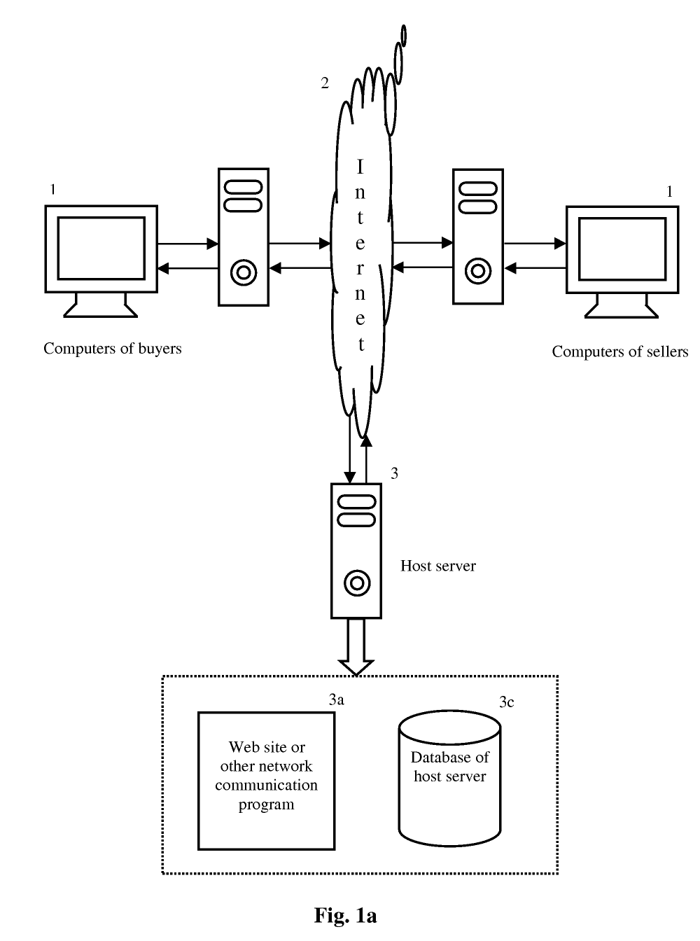

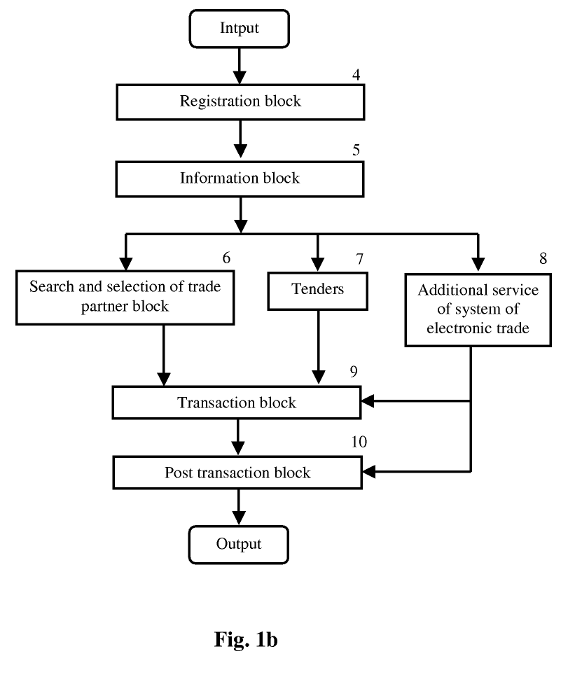

A system of global electronic trade for users including sellers and buyers (FIG. 1a) includes user computers for buyers and sellers 1 interacting via the internet 2 with a Web site or other network communication program 3a located on the host server 3; the database 3c containing offers of sellers and buyers and located on the host server; and the Internet and/or other communication networks 2.

Users can access the Web site from their computers by means of a Web browser. They can acquire the information necessary for business and execute transactions. After entering the main page of the Web site a user can work either as a registered user or in a free access mode. In the free access mode a user can:
get acquainted with the rules of working in the Web site and access other official regulating documents available in different languages of the world;
familiarize with the registration procedure;
familiarize with sections of sellers and buyers, access offers of sellers and buyers;
get familiar with the structure of the site, and so on.

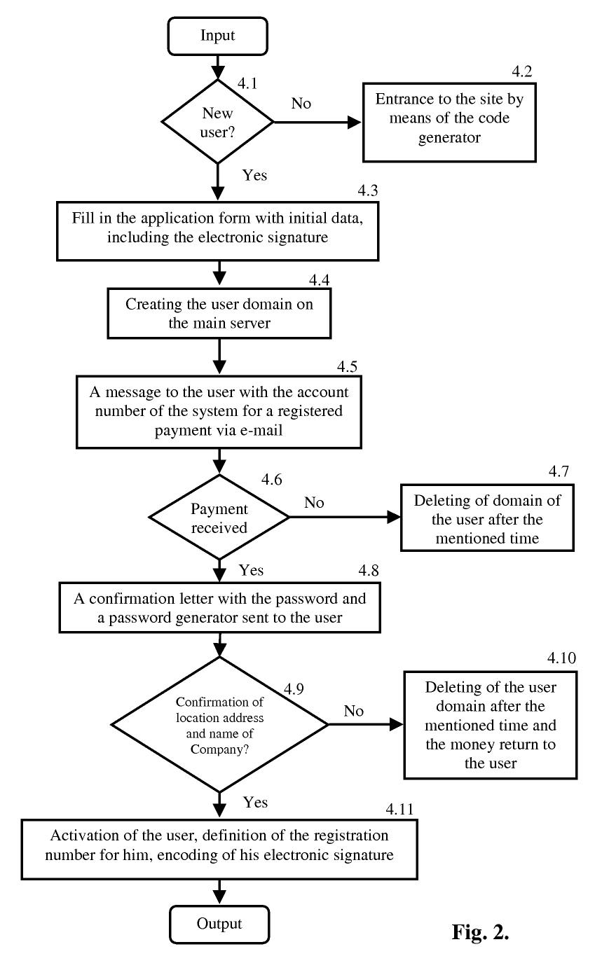

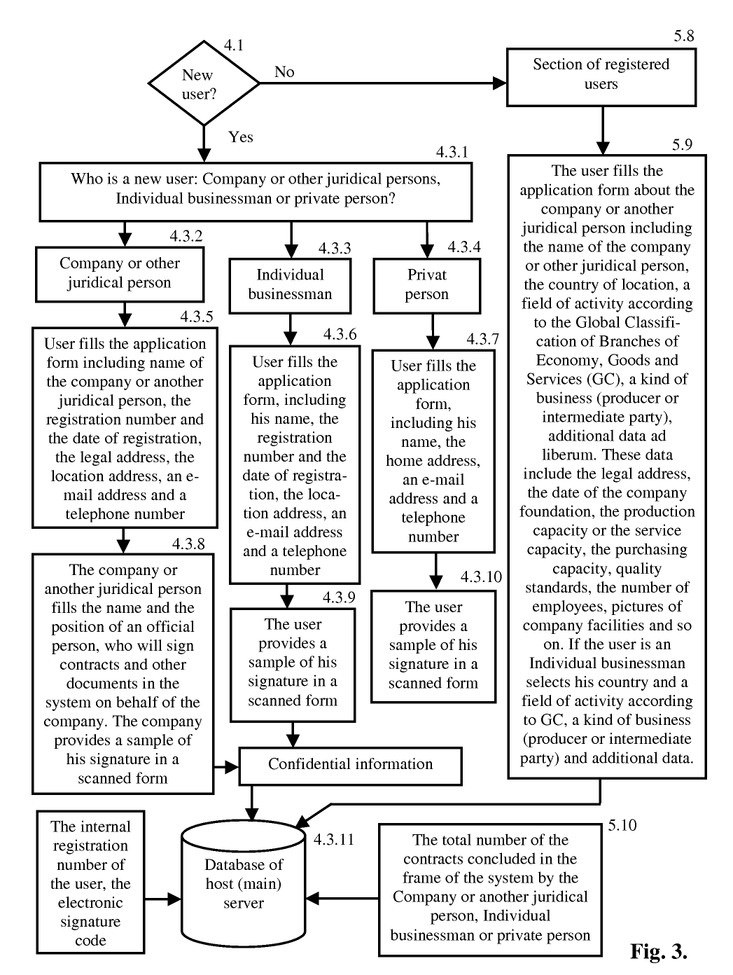

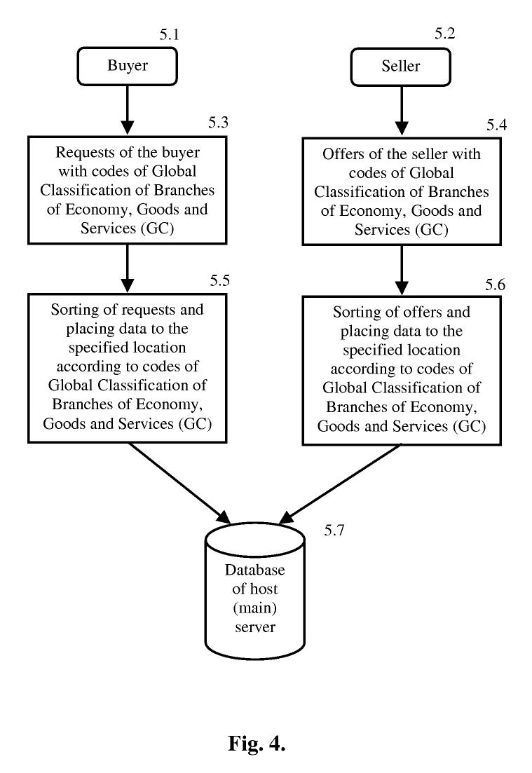

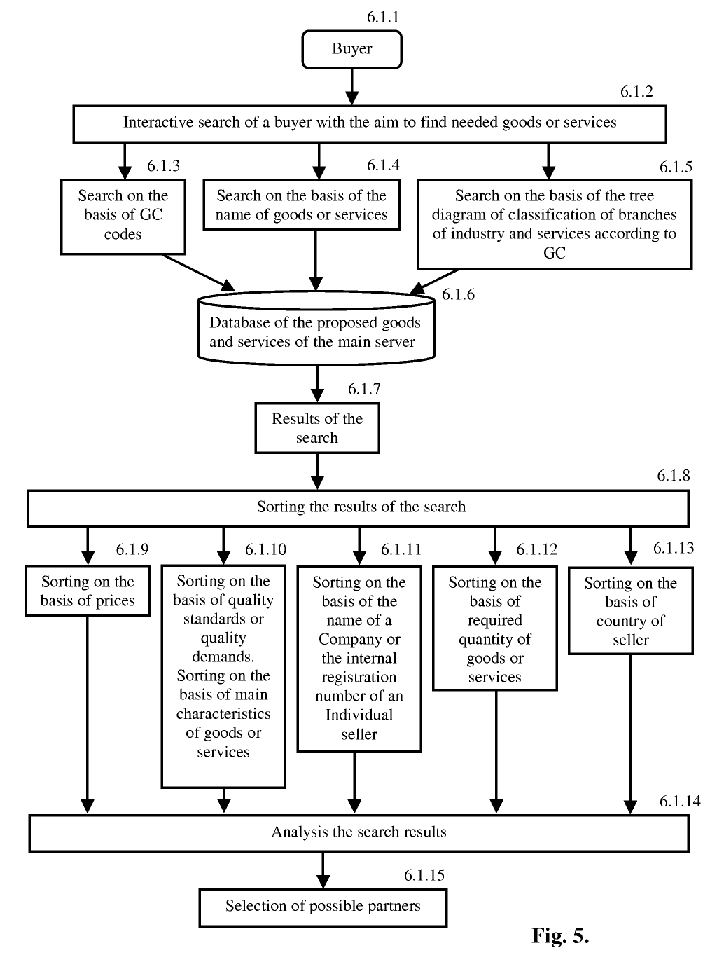

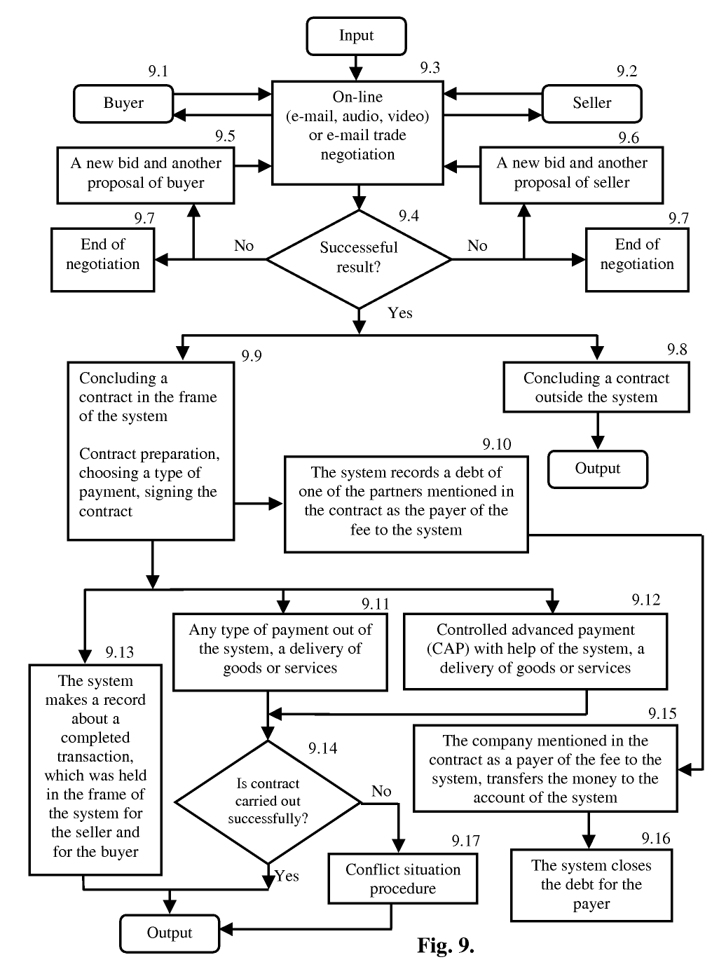

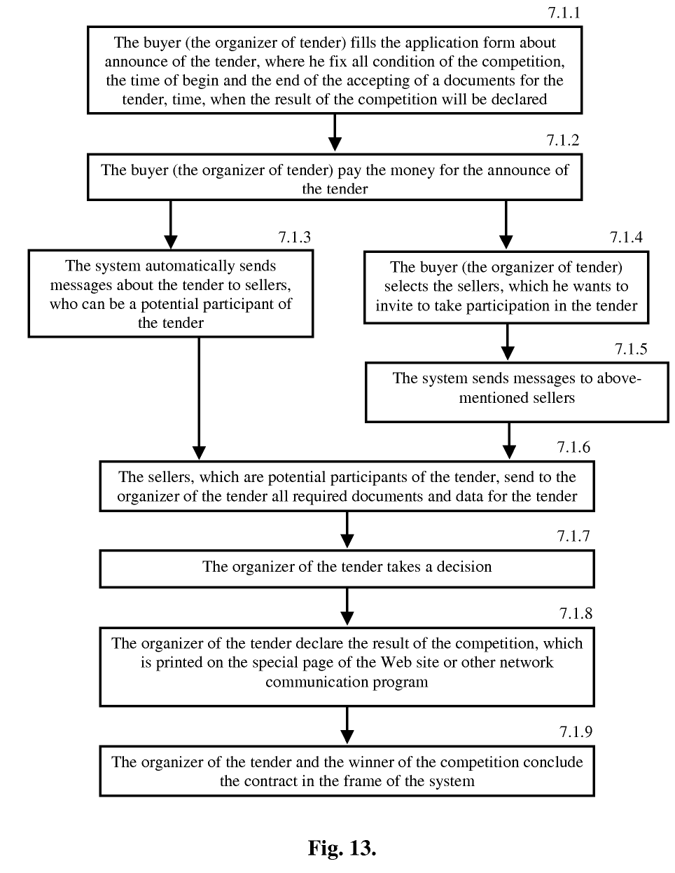

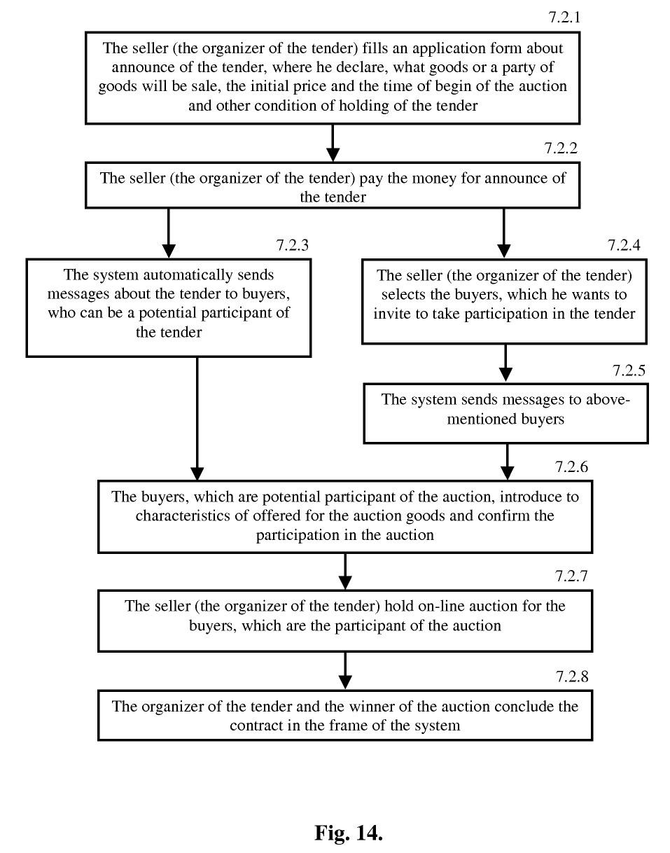

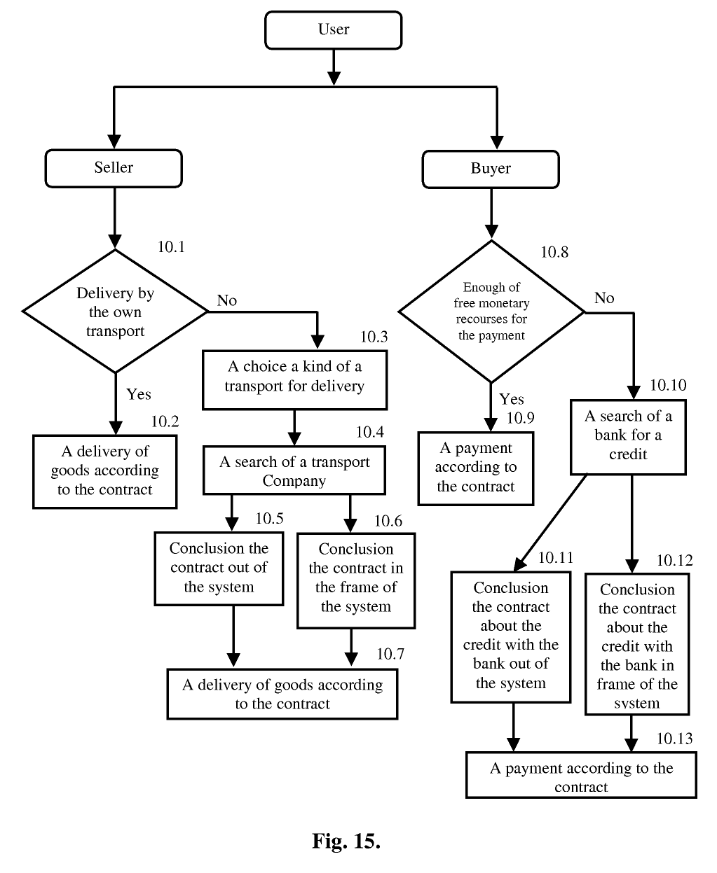

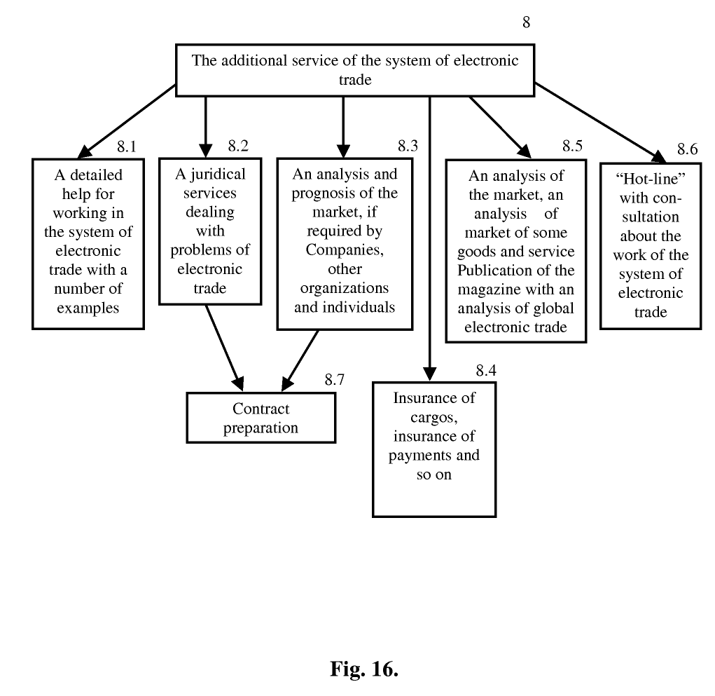

The Web site does not grant an access to the data of sellers or buyers for unregistered users. According to the invention, a method of global electronic trade (FIG. 1b) includes a registration block (4—see FIGS. 2 and 3), an information block (5—see FIGS. 3 and 4), a search and selection of trade partner block (6—see FIGS. 5-8), a block of the tenders (7—see FIGS. 13 and 14), a transaction block (9—see FIGS. 9-12), a post-transaction block (10—FIG. 15), and a block of additional services of the system of global electronic trade (8—see FIG. 16).

In order to register, the user must complete an application form (4.3) (FIG. 2). This form, for example, includes data about the company (or another legal entities), the name of the company or another juridical person, the registration number and the date of registration, the legal address, the location address, an e-mail address and a telephone number. If the user is a company or another entity, they have to fill in the name and the position of its official representative, who will sign contracts and other official documents on the behalf of the company or another juridical person.

The company provides an example of the official scanned signature. Companies having seals according to articles of association provide a sample of a scanned print of the seal. If the user is an individual businessman, they include their name in the application form, the registration number and the date of registration, the location address, an e-mail address and a telephone number. If the user is a private individual, they have to include their name in the application form, the home address, an e-mail address and a telephone number. An individual user has to give a scanned image of his signature. This information is considered confidential and will not be published in the freely accessible parts of the site. This information can be used for the contract preparation and other official documents of the system of global electronic trade.

The system allocates a user domain for a new user (4.4). In this domain all data of user will be stored.

Upon completion of the user registration, the system will send a message (4.5) to the provided e-mail address of the user with the account number, where the user must provide a registration fee. This fee is intended discourage casual users who can potentially impede the normal operation of the system.

In case if no payment is received during a certain period after the registration then the system deletes the allocated user domain with all the data (4.7).

After receiving the registration fee, a letter is sent to the user with the password and password generator by an express post (4.8) with a notification of the receipt. A contract with the postal service will oblige the service, for example, to confirm the identity of a receiving person and collect their passport data, the residence address and the company name, if applicable. In return the user gets the letter. Once the data is acquired the post will send it to the system. This data will be considered as private and will not be retrieved from the database unless a legal implication occurs involving this company or individual.

Confirmation (4.9) will be conducted. In case no confirmation is acquired of the user's location address as specified in the application form or the company name or the name of another juridical person, the system locks the reserved user domain.

If the user does not give a message to the system during a certain period, the system deletes a reserved domain of user and returns the registration fee (4.10).

In case of confirmation of user data, the system activates the user (4.11) and provides a registration number. The system encodes their electronic signature and seal. After receiving the password, the user becomes a registered user of the system. But in order to make transactions the user is required to enter the signature code, which will be also sent by post. The signature code will put the electronic signature in a contract or any other documents of the system of global electronic trade. The user will be able to work in the system only from the same IP address as provided during registration. The user will also get specially designed code generator. The user will be able to access the registered user domain only through this generator. The generator will be activated by the password received by the user. The same generator will also operate in the special security database located on the host server. The programs are identical. This way a couple of matching passwords will be generated at a new login. The program will generate a new password taking into account a combination of previously generated passwords, generation time and IP address. Thus a dynamic password will secure the connection between the registered computer of the user and the system.

The manually introduced signature code will provide an extra protection of the user domain, if the registered computer is accessed by an unauthorized person. The system will record the last few logins as well as the last few performed actions, which will inform the user of any unauthorized actions conducted on his behalf. Of course, the user will be requested to keep the signature code in a secure location. If the code is lost or could be seen by an outsider the user must request a new code immediately.

Upon a user request, a list of IP addresses will be accepted. Each new IP address will be provided with the password and a password generator, i.e., this generator might be different for each new IP. The same generator will be operating on a security database side located on the host server in order to provide a match.

These measures will bring the security of the system to considerably higher level.

After filling of registration form the user concludes an agreement with the system. This way the user confirms his responsibility for any breach of the national and International laws.

A user will be able to modify the name of the company, the registration number and the legal address. But in order to activate changes the user must repeat the registration procedure.

The information block includes the following databases. The first part of the database of legal entities, e.g., companies, Individual businessman or private person is formed on the basis of data obtained during registration procedure (4.3.1-4.3.10) (FIG. 3). This information is considered confidential. Another part of information about legal entities (FIG. 3) is formed on the basis of data provided by the legal entities in the application forms (5.9). These data include the name of the legal entity, the country of location, a field of activity according to the Global Classification of Branches of Economy, Goods and Services (GC), a kind of business (producer or intermediate party). The Global Classification of Branches of Economy, Goods and Services (GC) is a classification covering all the known branches of world Economy and all the known names of goods and services. There is a possibility for legal entities to provide additional information for a general use. These additional information includes the legal address, the date of the company foundation, the production or service capacity, the purchasing capacity, quality standards, the number of employees, pictures of facilities and so on. More detailed information about companies a user can find on their sites, which can be included as additional information on the company. If the user is an Individual businessman he selects his country and a field of activity according to GC, a kind of business (producer or intermediate party). The Individual businessman can provide additional information also. These additional information includes the address, the date of the beginning of activity, the production or service capacity, the purchasing capacity, quality standards, pictures of facilities and so on. If the user is a private person he selects his country and a field of activity according to GC only. For the sake of confidentiality the internal registration number of an Individual businessman or a private person can replace their names. For instance, the user will see the line like this: “Individual businessman, internal registration number N” or “Private person, internal registration number N”. Data on a company or an Individual businessman or a private person will include the total number of contracts concluded in the frame of the system also. This record will be done by the system of global electronic trade automatically.

Another database is the database of goods and services (FIG. 4). The database of goods and services is formed on the basis of offers of sellers and requests of buyers. A buyer can select the section of buyer's requests. He fills the application form, where he has to provide the name of goods or services he wants to buy. He has to provide the code of a required item from the Global Classification of Branches of Economy, Goods and Services (GC) (5.3). The buyer can select the quantity of goods or volume of services, main characteristics of goods or services, desired price, desired local or international quality standard, desired quality demands, the country of production. These data is considered main and used by the search engine of the system. Additionally buyers can require certain special technical characteristics, desired delivery terms and so on. Filled in request is stored in the database of goods and services. Sellers can search through these requests in the frame of the system and access additional information if needed.

Sellers have similar options. A seller selects the section of seller's offers (FIG. 4). He fills the application form, where he has to provide the name of goods or services he wants to sale. He has to provide the code of the Global Classification of Branches of Economy, Goods and Services (GC) (5.4). The seller indicates the price of good or service. He can show the exact, an approximate, a sample price of goods or services or the initial price for future negotiations. He can refuse to declare any price. But in this case his goods or services will not participate in sorting on the basis of price. He can indicate a quantity of offered goods, if it is a one-time sale, or the production or services capacity for a long time delivery, if he wishes so and so on. He can indicate the quality of offered goods, main characteristics of goods or services and the availability of International quality certificates and other quality certificates. The seller can also give any additional information about goods and services, for example, special technical characteristics, photos of goods and so on. Upon completion the offer is stored in the database of goods and services and buyers will be able to access it immediately. Buyers can access additional data if needed.

Requests of buyers and offers of sellers are sorted on the basis of their GC codes and placed to the database on the host server (5.5-5.7).

Buyer or seller can modify their requests and offers through filling a special form.

Search and selection of trade partners is one of the most important parts of the wholesale trade between companies. The system provides an interactive and automatic search for trade partners. FIG. 5 shows how a buyer can perform an interactive searching to find needed goods or services. The buyer can choose a type of search. There are three main searching types:
searching on the basis of GC (6.1.3), when buyer provides GC codes;
searching on the basis of the name of goods or services (6.1.4), when buyer provides the name of goods or services;
searching on the basis of a tree diagram of classification of branches of industry according to GC (6.1.5), when buyer selects the needed branch, then a segment of branch and so on.

As a result of search (6.1.7) the buyer acquires a list of sellers offering this good or service, with an indication of name of seller, the country of seller, quality certificates, a quantity of offered goods, the price of goods or services and main characteristics of goods or services. The buyer can make sorting of obtained list or a part of it on the basis of the following approaches:
on the basis of prices (6.1.9),
on the basis of quality demands (6.1.10),
on the basis of main characteristics of goods or services (6.1.10),
on the basis of the name of a Company or the internal registration number of an Individual seller (6.1.11),
on the basis of needed quantity of goods (6.1.12),
on the basis of country of seller (6.1.13).

A parallel sorting will be offered where all the found items are sorted according the specified parameter. Out of this sorting a selection can be made and sorting within this selection can be conducted locally, which is referred further as an embedded sorting.

After the analysis of search results (6.1.14) the buyer can get a list of possible trade partners.

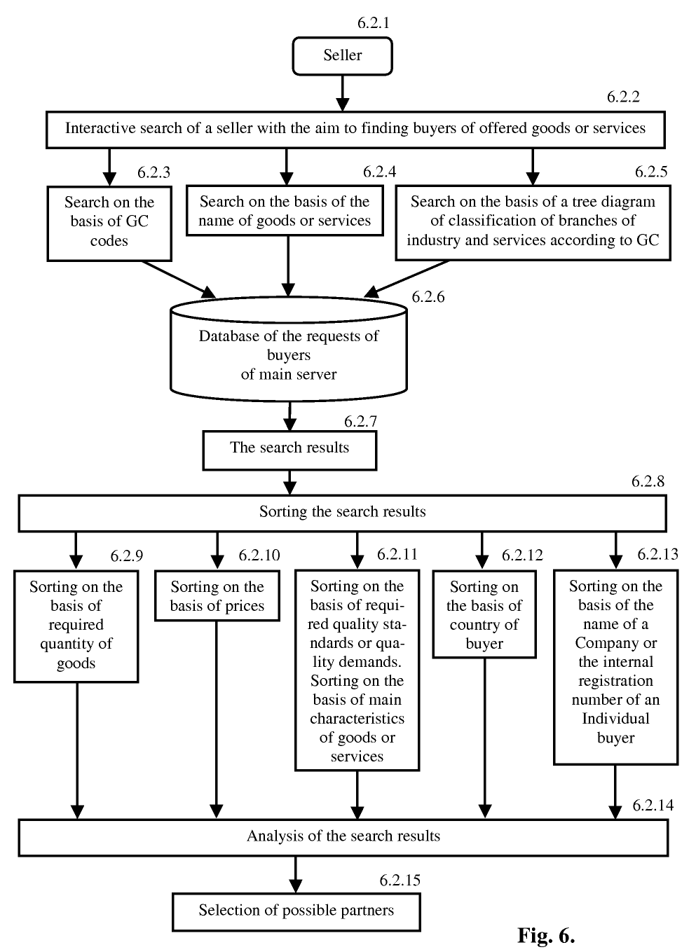

FIG. 6 shows an interactive search of a seller with the aim to find potential buyers for offered goods or services. The seller selects a type of search out of the same search types as in the previous case. Upon completion of search (6.2.7) the seller gets a list of companies or Individual buyers, looking for offered goods or services, with an indication of a name buyer, a country of a buyer, required quality certificates, required quantity of goods, the desired price of goods or services and main characteristics of goods or services. The seller can make sorting of obtained list or part of it on the basis of the following approaches:
on the basis of a required quantity of goods (6.2.9),
on the basis of required prices (6.2.10),
on the basis of quality demands (6.2.11),
on the basis of required main characteristics of goods or services (6.2.11),
on the basis of country of buyer (6.2.12) and
on the basis of the name of a Company or the internal registration number of an Individual buyer (6.2.13).

As in the previous case it will be possible to make a parallel or an embedded sorting. After analysis of the search results (6.2.14) the seller can obtain a list of possible trade partners.

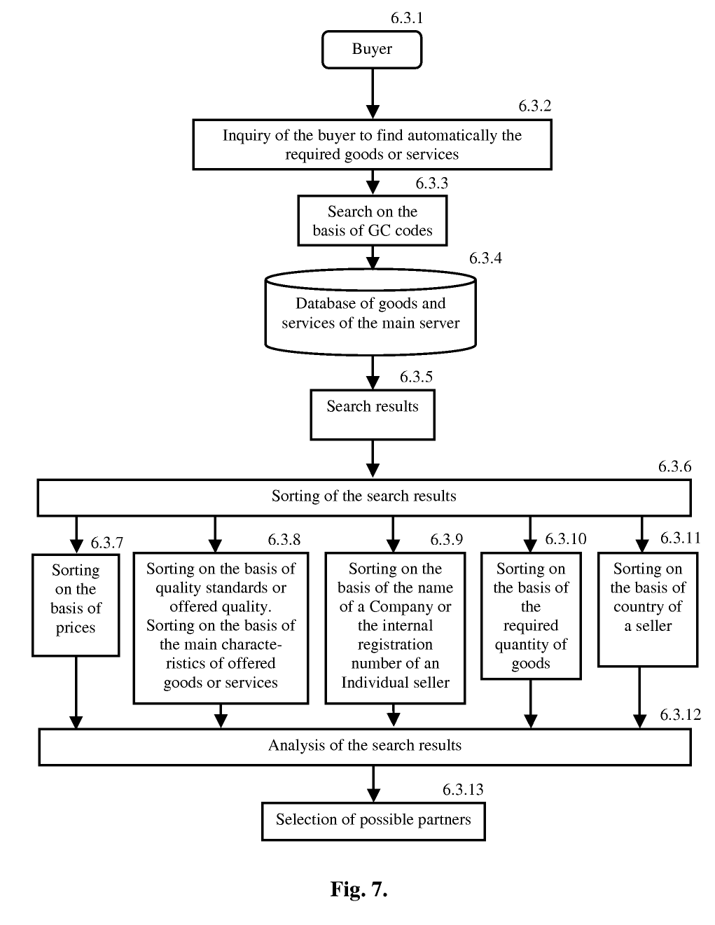

FIG. 7 describes an automatic search of trade partners by a buyer. The buyer opens a special form (6.3.2) and fills all the needed data for searching: the names and the codes of goods or services; demands to quality, including the name or the number of a quality standard, the main characteristics of goods or services; a quantity of goods, a single purchase or long-time requirement; a preferred country of a seller; a desired price of goods or services, or the desired range of the price. The search is carried out on the basis of GC codes (6.3.3). Upon completion of the search, the results (6.3.5) become available for user. Counteroffers of sellers, which completely or nearly completely match the requirements of the buyer, take the first positions in the list of the results. The buyer can localize his requests through the same form and repeat the search. He can then sort the search results on the basis of prices (6.3.7), on the basis of offered quality, on the basis of main characteristics of offered goods or services (6.3.8), on the basis of the name of a Company or the internal registration number of an Individual seller (6.3.9), on the basis of the offered quantity of goods (6.3.10), on the basis of the country of a seller (6.3.11). He can do a parallel or an embedded sorting. After analysis of the results of this automatic search (6.3.12) the buyer can get a list of possible trade partners.

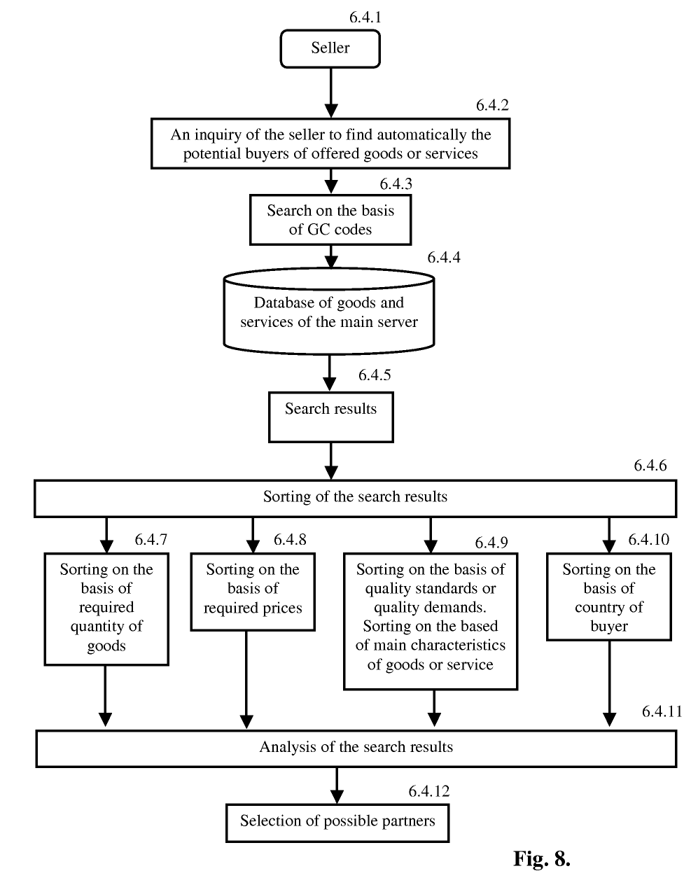

FIG. 8 describes an automatic search of trade partners by a seller. The seller opens a special form (6.4.2) and fills all the data needed for searching: the name and the code of offered goods or service; the offered quality of goods, including the name or the number of a quality standard, the main characteristics of offered goods or services; a quantity of goods for a one-time delivery or the production capacity of the seller for a long-time delivery; the exact, an approximate, a sample price of goods or services or the initial price for future negotiations. The search is implemented on the basis of GC codes (6.4.3). The search results become available for user (6.4.5). Counteroffers of buyers, which completely or nearly completely match the offer of the seller, take the first positions in the list of the results. The seller can localize his offer through the same form and repeat the search. He can then sort the search results on the basis of a requested quantity of goods (6.4.7), on the basis of prices (6.4.8), on the basis of quality demands, on the basis of the main characteristics of goods or services (6.4.9), on the basis of country of buyer (6.4.10). He can do a parallel sorting or an embedded sorting. After analysis of the results of automatic search (6.4.11) the seller can to get the list of possible trade partners.

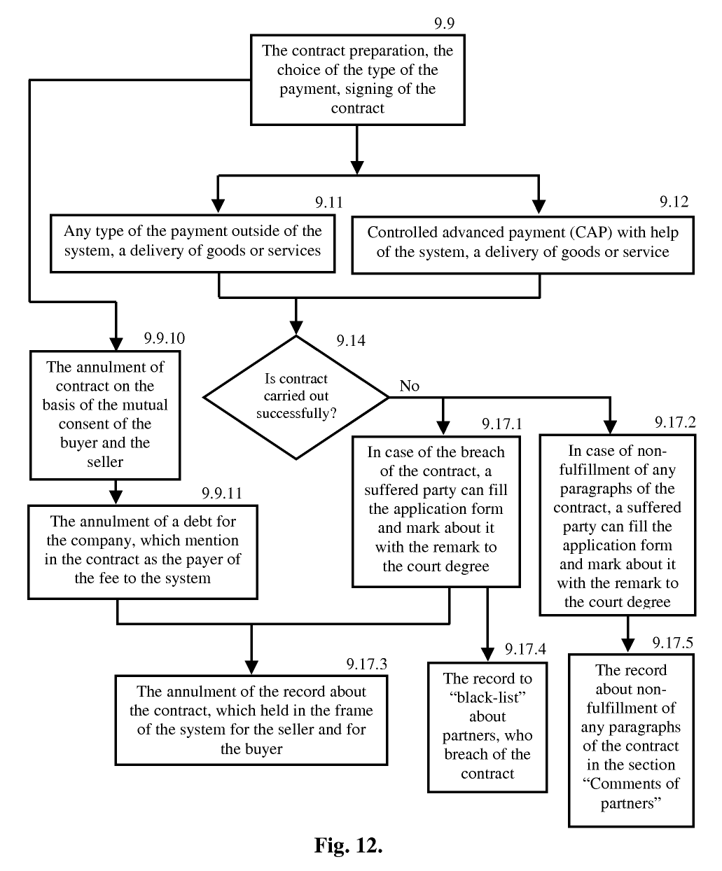

FIG. 9 describes the transaction block. Upon definition of potential partners sellers and buyers can engage into trade negotiations. They can do this negotiation on-line using provided audio or video services or internal e-mail. Audio or video can be conducted through a special window in the site. Negotiations can be done as an exchange of text or e-mail messages, or via telephone (9.3). If the result of negotiations is successful (9.4), parties can prepare a contract. The contract can be concluded in the frame of the system (9.9) or outside the system (9.8). If the contract is concluded in the frame of the system, the system records a debt to one of the partners, who will be named in the contract as the payer of a fee to the system (9.10). Partners can choose a type of payment during concluding the contract. It can include any type of payment outside the system (9.11) and the Controlled Advanced Payment (CAP) with the help of the system (9.12). After concluding the contract, the system makes a record about the contract, concluded in the frame of the system, for the seller as well as for the buyer (9.13). This record will be entered into the database of the companies, where the total number of contracts is shown. This record will be shown also attached to each request or an offer made by this company in sections of buyers or sellers. Before the date mentioned in the contract the party, named in the contract as the payer, transfers the money to the system (9.15). After that the system closes the debt to this company (9.16). If the contract is carried out successfully, then the transaction process is finished. Otherwise the procedure of conflict situation is initiated (FIG. 12).

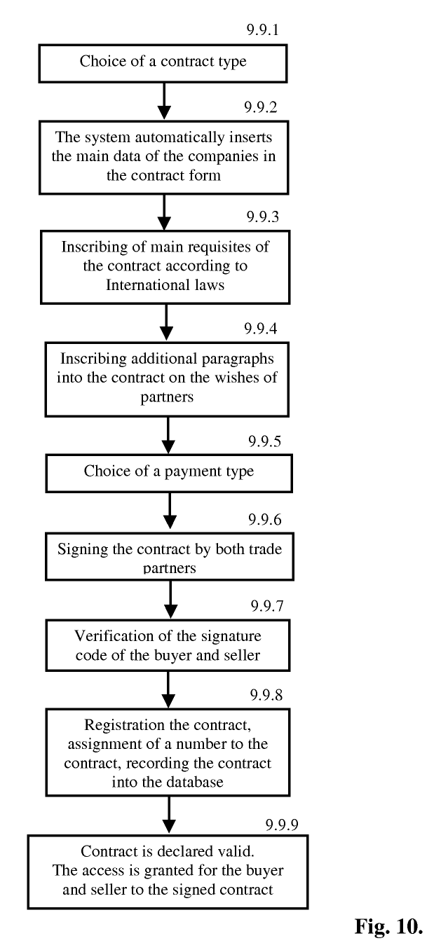

FIG. 10 describes a process of preparing and concluding the contract. The trade partners are able to choose a suitable type of the contract depending on the type of activities considered (9.9.1). The system proposes different kinds of contracts depending on the activity type, type of parties as juridical persons and so on. The contracts are prepared according to the International legal regulations. After that the system automatically inserts the main data about the companies in the contract form (9.9.2). Then the partners inscribe the main requisites into the contract according to the International laws in the contract form (9.9.3). The main requisites can include: the name of goods or services, the quantity of sold goods or services. The contract will not registered in the system until these data is not inscribed. After that the partners can introduce additional paragraphs into the contract if they wish so (9.9.4). The partners define the type of payment (9.9.5). Then the partners have to decide who will pay the fee to the system, and mention this company in the contract. The partners have to specify the date of delivery of goods or the fulfillment of services and the payment date. After that the partners insert electronic signature into the contract through entering corresponding codes in the special fields (9.9.6). The partner having a seal according to the article of associations must set the seal code in the determined place. After that the system verifies the introduced signature and seal codes (9.9.7). If all the data is valid, the system places scanned signatures and seals of each party to the determined places in the contract. After that the system registers the contract, assigns the number to the contract and records the contract into the database (9.9.8). After the contract registration is declared valid. Both parties are granted an access to the contract (9.9.9) in order to be able to print it, store in another location and so on.

The contract will be registered only in case if signed by both parties, so no party can declare, that the contract was not signed. This procedure increases the reliability of the contract.

After the contract registration, the record about contract will be entered in the list of contracts of each party appearing in the special section of the system of electronic trade.

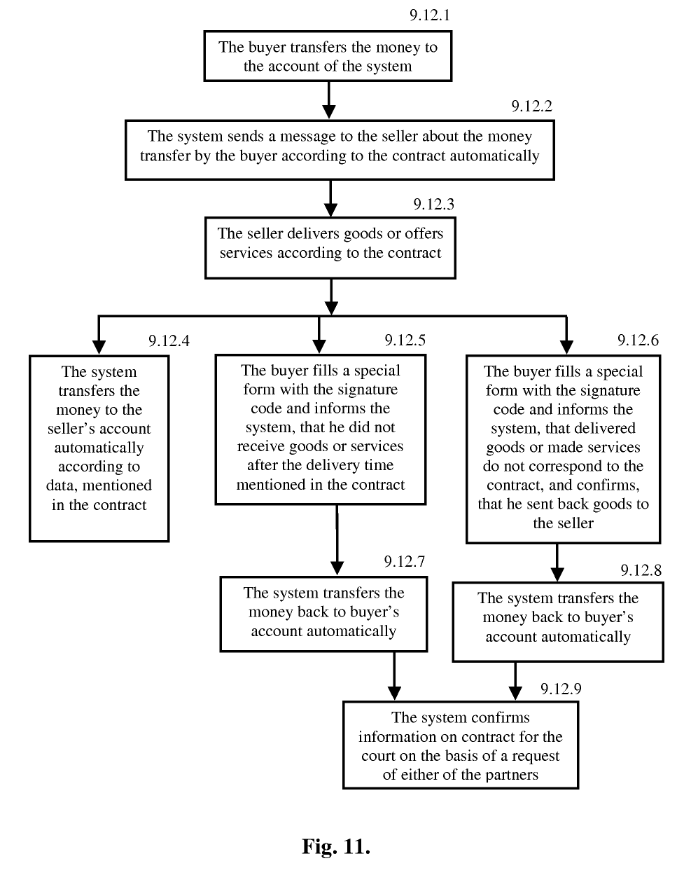

FIG. 11 describes the Controlled Advanced Payment (CAP) procedure conducted with help of the system. The buyer transfers the money to the account of the system (9.12.1). Then the system sends a message to the seller about the money transfer from the buyer (9.12.2) automatically. After that the seller is must deliver goods or make services according to the contract (9.12.3). If everything is normal, the buyer sends no messages to the system, and the system automatically transfers the money to the seller's account according to terms specified in the contract (9.12.4). If the buyer does not get goods or services within the time frame specified in the contract, then the buyer has to fill a special form with his electronic signature (9.12.5) provided. The buyer informs the system, what he did not get goods or services within the delivery time frame specified in the contract. After receiving this message the system transfers the money back to the buyer's account (9.12.7) automatically. In case if delivered goods or offered services did not correspond to the contract, then buyer fills a corresponding form with his electronic signature provided (9.12.6). The buyer informs the system, what delivered goods or offered services did not correspond to the contract, and confirms, what he has sent back goods to the seller or do not take over the services. After that the system transfers the money back to the buyer's account (9.12.8) automatically.

FIG. 12 describes the procedure of solving a conflict situation and a situation of an annulment of the contract. The both parties can make changes in the contract before the beginning of the due date of the contract by means of a special form. If the both parties decide to cancel the contract, they must fill a special application form and both sign it (9.9.10). After signing this application form by both parties, the contract will be cancelled. After that, the debt of the payer of the fee to the system will be cancelled as well (9.9.11). Certainly, the record about the contract fulfilled in the frame of the system will be also cancelled (9.17.3) automatically. In case of a breach of the contract by any party, the offended party can fill the application form and provide a reference on the court decision (9.17.1). Then, a new record appears in the “black-list” containing information on all the companies breaching their contracts (9.17.4) automatically. The annulment occurs of the previously made record about this contract in the list of contracts of the seller and the buyer (9.17.3) automatically. In case of a non-fulfillment of any paragraphs of the contract by one party, the offended party can fill the application form and provide a reference on the court decision (9.17.2). After that, a record about non-fulfillment of any paragraphs of the contract by this party in the section “Comments of partners” (9.17.5) appears automatically. “Comments of partners” and the “black-list” are accessible for all the users.

FIG. 13 describes the procedure of holding tenders by buyers. A buyer (the organizer of the tender) fills the application form about announcement of the tender, where he determines parameters of the competition, the time frame for accepting the documents for the tender, the time when the result of the tender will be declared (7.1.1). Then the buyer (the organizer of the tender) pays the money for the announcement of the tender (7.1.2). There are two ways for notifying potential participants about the tender. In the first way the system automatically sends messages about the tender to potential participants on the basis of declared parameters by internal e-mail (7.1.3). In the second way, the buyer (the organizer of the tender) invites sellers himself (7.1.4). Then the system sends messages to above-mentioned sellers by internal e-mail (7.1.5). The potential participants of the tender are required to send all the needed data and documents for the tender to the organizer of the tender (7.1.6). After having analyzed these data the organizer of the tender takes a decision (7.1.7). Then the organizer declares the result of the tender, which is published on the special page of the Web site or other network communication program (7.1.8). Finally, the organizer of the tender and the winner of the competition conclude the contract in the frame of the system (7.1.9).

FIG. 14 describes the procedure of holding the tender by sellers. The seller (the organizer of the tender) fills the application form for announcement of the tender, where he declares goods or a lot of goods to be sold, the initial price and the time frame of the auction and other parameters for holding the tender (7.2.1). Then the seller, as the organizer of the tender, pays the money for the announcement of the tender (7.2.2). After that a notification about the tender is sent like in the previous case. The buyers, as potential participants of the auction, get familiar with characteristics of the offered goods and confirm their participation in the auction (7.2.6). After that, the organizer of the tender holds the on-line auction for the participants of the auction (7.2.7). Finally, the organizer and the winner of the tender conclude the contract in the frame of the system (7.2.8).

FIG. 15 describes the post-transaction procedure. A seller must estimate himself delivery terms of his goods or services (10.1). If the seller does not own any transport, he can choose a transport company (10.3). A buyer must estimate his free monetary recourses available for the payment (10.8). If the buyer does not have enough free monetary recourses to make payment, he must find a credit (10.10).

FIG. 16 describes additional services of the system of electronic trade. These services include:
a detailed help for working in the system of electronic trade with a number of examples (8.1),
a juridical services dealing with problems of electronic trade (8.2),
an analysis and prognosis of the market, if required by Companies, other organizations and individuals (8.3),
an insurance of cargos (8.4),
an insurance of payments and so on (8.4),
an annual analysis of the market (8.5),
analysis of the market of some goods and services (8.5),
a publication of the magazine with an analysis of the global electronic trade (8.5), and
“Hot-line” with consultation about the work of the system of electronic trade (8.6).

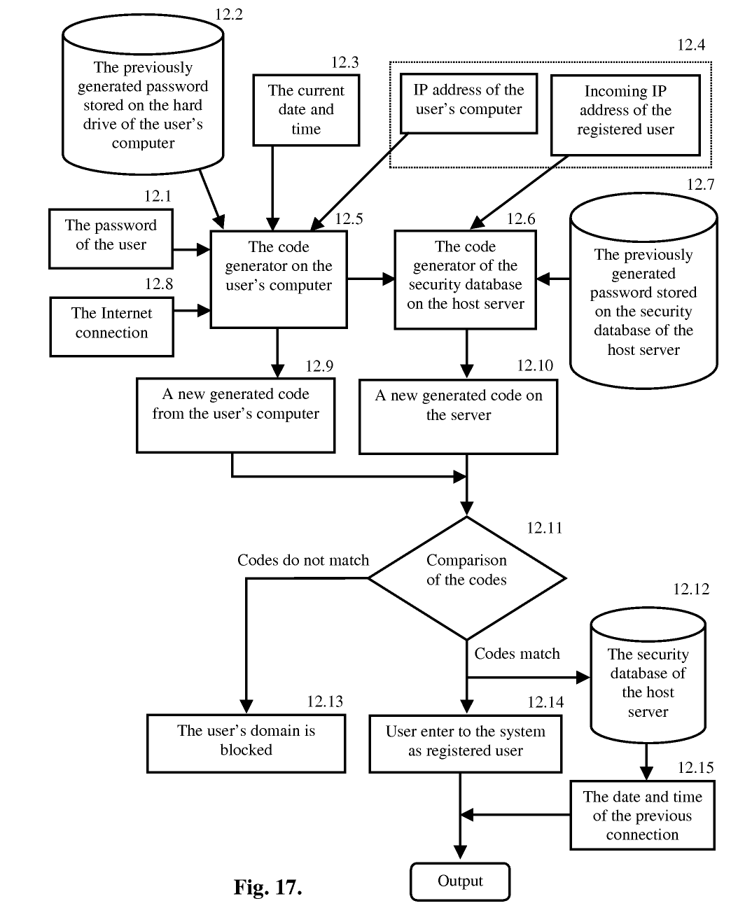

FIG. 17 describes the security procedure of the system. A code generator must be executed before entering the system of electronic trade. The code generator starts by means of the user password (12.1). The code generator reads the previously generated password stored on the hard drive of the user's computer (12.2), the current date and time (12.3), the IP address of the user's computer (12.4) and verifies the Internet connection (12.8). If the connection is missing, then the generator exits without any further action.

If the connection is valid, the code generator (12.5) makes a new password (12.9) and sends it to the host server together with the exact time when the password was generated and the previous password. The code generator of the security database on the host server (12.6) generates a verification password (12.10) on the basis of the acquired time, the incoming IP address (12.4) and the previous successful user's password stored in the security database on the host server (12.7).

The host-server compares the sent password with the verification password as well as the previous passwords (12.11). If these codes match the user immediately gets an access to the system of electronic trade. (12.14). The created passwords replace the previously stored passwords on the user's computer and the security database (12.12). The date and time of generation of the password is stored in the security database (12.12) also. Otherwise, if any data mismatch the user's domain is blocked (12.13) and any corresponding information in the security database is deleted, so that no one can login from the registered IP-address anymore. In the case of successful connection, user gets the time of previous connection with the system of electronic trade (12.15).

The storage of the date and time of the previously connection can help for user to discover unsanctioned enter to the system of electronic trade from the user's computer also.

The system and method of global electronic trade in the Internet described above can be applied for a system of local electronic trade in the Internet. By a system of local electronic trade in the Internet we shall imply a local territorial system of electronic trade, for example, a system of electronic trade of a separate country or any group of countries in the Internet. By a system of local electronic trade in the Internet we shall consider also a system of electronic trade in the Internet of separate group of goods or separate group of services, for example, an electronic market of nonferrous metals or an electronic market of transport services. This can also be an electronic market of specific goods or specific services in the Internet, for example, an electronic market of paper or an electronic market of the watches or an electronic market of the tourist service, an electronic market of the dentist services and so on.

The database of requests of buyers and the database of offers of sellers of any local territorial system of electronic trade can be formed on the basis of the Global Classification of Branches of Economy, Goods and Services (GC) or on the basis of the Local Classification of Branches of Economy, Goods and Services (LC). The Local Classification of Branches of Economy, Goods and Services (LC) is a classification covering all the known branches of local Economy and all the known names of goods and services in the local market.

The database of requests of buyers and the database of offers of sellers of any system of electronic trade in the Internet of separate group of goods or separate group of services can be formed on the basis of a Classification of Properties and Characteristics of Separate Group of Goods or Separate Group of Services (CPC). The Classification of Properties and Characteristics of Separate Group of Goods or Separate Group of Services is a classification covering all world-known properties and characteristics of separate group of goods or separate group of services of the said electronic market of a separate group of goods or a separate group of services.

The database of requests of buyers and the database of offers of sellers of any system of electronic trade in the Internet of specific goods or specific services can be formed on the basis of a Classification of Properties and Characteristics of Specific Goods or Specific Services (CPC). The Classification of Properties and Characteristics of Specific Goods or Specific Services is a classification covering all world-known properties and characteristics of specific goods or specific services of the said electronic market of specific goods or specific services.

The system of local electronic trade also provides an interactive and automatic search for trade partners. The buyer can choose a type of search. There are three main searching types:
searching on the basis of GC, LC or CPC, when buyer provides GC, LC or CPC codes;
searching on the basis of the name of goods or services, when buyer provides the name of goods or services;
searching on the basis of a tree diagram of classification of branches of industry according to GC or LC, when buyer selects the needed branch, then a segment of branch and so on.

As a result of search the buyer acquires a list of sellers offering this good or service, with an indication of the name of a seller, the country of a seller, quality certificates, a quantity of offered goods, the price of goods or services and main characteristics of goods or services. The buyer can make sorting of obtained list or a part of it on the basis of the following approaches:
sorting on the basis of a desired price of goods or services,
sorting either on the basis of desired quality standards or quality demands,
sorting on the basis of main characteristics of goods or services,
sorting either on the basis of the name of a company or another juridical person or on the basis of the internal registration number of an individual seller,
sorting of search results on the basis of a required quantity of goods or services, and
sorting of search results on the basis of the country of a seller.

The seller selects a type of search out of the same search types as in the previous case. Upon completion of search the seller gets a list of companies or Individual buyers, looking for offered goods or services, with an indication of the name of a buyer, a country of a buyer, required quality certificates, a required quantity of goods, the desired price of goods or services and the main characteristics of goods or services. The seller can make sorting of obtained list or part of it on the basis of the following approaches:
sorting on the basis of an offered quantity of goods or services,
sorting on the basis of an offered price of goods or services,
sorting either on the basis of quality standards or requirements on quality,
sorting on the basis of the main characteristics of goods or services,
sorting on the basis of the country of a buyer,
sorting either on the basis of the name of a company or another juridical person or on the basis of the internal registration number of an individual buyer.

Although a few embodiments of the present invention have been shown and described, it would be appreciated by those skilled in the art that changes may be made in this embodiment without departing from the principles and spirit of the invention, the scope of which is defined in the claims and their equivalents thereof.

What is claimed is:

1. A system of local electronic trade via the Internet for users, including sellers and buyers as equitable trade participants, comprising:
a host server including a database and a Web site or network communication program with multi-language support; and
user computers capable of communicating with the host server,
wherein the host server registers the users, provides information regarding goods or services to the user computers, searches and selects trade partners, holds tenders, conducts transactions, and protects information.

2. A method of local electronic trade for sellers and buyers via the Internet, comprising
registering the sellers and the buyers;
providing information regarding goods or services to the registered sellers and buyers;
selecting trade partners based on the provided information;
holding tenders for the trade partners;
conducting transactions between the trade partners;
conducting a post-transaction procedures; and
protecting the seller and the buyer information.

3. The method according to claim 2, wherein the providing information regarding goods or services for a system of local electronic trade, which is a local territorial system of electronic trade, comprises providing information in accordance with a Global Classification of Branches of Economy, Goods and Services (GC), covering all the known branches of the world Economy and all the known names of goods and services, or in accordance with a Local Classification of Branches of Economy, Goods and Services (LC), covering all the known branches of a local Economy and all the known names of goods and services in the local market.

4. The method according to claim 2, wherein the providing information regarding goods or services for a system of local electronic trade, which is a system of electronic trade in the Internet of separate group of goods or separate group of services, comprises providing information in accordance with a Classification of Properties and Characteristics of Separate Group of Goods or Separate Group of Services (CPC), covering all the world-known properties and characteristics of separate group of goods or separate group of services of the said electronic market of a separate group of goods or a separate group of services.

5. The method according to claim 2, wherein the providing information regarding goods or services for a system of local electronic trade, which is a system of electronic trade in the Internet of specific goods or specific services, comprises providing information in accordance with a Classification of Properties and Characteristics of Specific Goods or Specific Services (CPC), covering all the world-known properties and characteristics of specific goods or specific services of the said electronic market of specific goods or specific services.

6. The method according to claim 2, wherein the selecting trade partners comprises interactive searching for goods and services by a buyer on the basis of the Global Classification of Branches of Economy, Goods and Services (GC), the Local Classification of Branches of Economy, Goods and Services (LC), the Classification of Properties and Characteristics of Goods or Services (CPC).

7. The method according to claim 2, wherein the selecting trade partners comprises interactive searching for buyers of goods and services by a seller on the basis of the Global Classification of Branches of Economy, Goods and Services (GC), the Local Classification of Branches of Economy, Goods and Services (LC), a Classification of Properties and Characteristics of Goods or Services (CPC).

8. The method according to claim 2, wherein the selecting trade partners comprises automatic searching for goods and services by a buyer on a basis of the Global Classification of Branches of Economy, Goods and Services (GC), the Local Classification of Branches of Economy, Goods and Services (LC), the Classification of Properties and Characteristics of Goods or Services (CPC).

9. The method according to claim 2, wherein the selecting trade partners comprises automatic searching for buyers of goods and services by seller on the basis of the Global Classification of Branches of Economy, Goods and Services (GC), the Local Classification of Branches of Economy, Goods and Services (LC), the Classification of Properties and Characteristics of Goods or Services (CPC).

10. A method of providing information for a system of local electronic trade, comprising:
creating a database of goods and services, which is formed on the basis of offers of sellers and requests of buyers and on the basis of the Global Classification of Branches of Economy, Goods and Services (GC), the Local Classification of Branches of Economy, Goods and Services (LC), the Classification of Properties and Characteristics of Goods or Services (CPC) including a price of offered and required goods and services, a quantity of offered and required goods or a volume of offered and required services and characteristics of offered and required goods and services;
creating a database of information regarding companies, individual businessmen or private persons, including the main and additional data about companies or other juridical persons, Individual businessmen or private persons into this database; and
creating of the database of confidential information for preparation of contracts and other official documents.

11. A method of searching for required goods and services by a buyer in the system of local electronic trade, comprising:
searching on the basis of the Global Classification of Branches of Economy, Goods and Services (GC) code, or on the basis of the Local Classification of Branches of Economy, Goods and Services (LC) code, or on the basis of the Classification of Properties and Characteristics of Goods or Services (CPC) code; and
sorting obtained search results, wherein the sorting comprises:
sorting on the basis of a desired price of goods or services,
sorting either on the basis of desired quality standards or quality demands,
sorting on the basis of main characteristics of goods or services,
sorting either on the basis of a name of a company or other juridical person or on the basis of the internal registration number of an individual seller,
sorting of search results on the basis of a required quantity of goods or services, and
sorting of search results on the basis of the country of a seller.

12. A method of searching for buyers of offered goods and services by a seller in the system of local electronic trade, comprising:
searching on the basis of the Global Classification of Branches of Economy, Goods and Services (GC) code, or on the basis of the Local Classification of Branches of Economy, Goods and Services (LC) code, or on the basis of the Classification of Properties and Characteristics of Goods or Services (CPC) code; and
sorting obtained search results, wherein the sorting comprises:
sorting on the basis of an offered quantity of goods or services,
sorting on the basis of an offered price of goods or services,
sorting either on the basis of quality standards or requirements on quality,
sorting on the basis of main characteristics of goods or services,
sorting on the basis of the country of a buyer,
sorting either on the basis of the name of a company or another juridical person or on the basis of the internal registration number of an individual buyer.
